(19) United States
(12) Patent Application Publication
(10) Pub. No.: US 2013/0311461 A1
(43) Pub. Date: Nov. 21, 2013

(54) SYSTEM AND METHOD FOR SEARCHING RASTER DATA IN THE CLOUD

(71) Applicant: NerVve Technologies, Inc., Buffalo, NY (US)

(72) Inventors: Jacob Herbert Goellner, East Aurora, NY (US); Thomas Edward Slowe, Buffalo, NY (US)

(73) Assignee: NerVve Technologies, Inc., Buffalo, NY (US)

(21) Appl. No.: 13/893,391

(22) Filed: May 14, 2013

Related U.S. Application Data
(60) Provisional application No. 61/647,547, filed on May 16, 2012.

(51) Int. Cl. G06F 17/30

(52) U.S. Cl. CPC G06F 17/3087; G06F 17/3053
USPC 707/724; 707/723

(57) ABSTRACT

A method includes the steps of: providing a computer based raster data search system; providing raster data; providing one or more search models as a search criteria; receiving as input the raster data; transforming by computer the raster data into a mathematical representation of the appearance of the raster data; storing the mathematical representation of the appearance of the raster data as a set of models in a database; comparing by computer at least one search model to the set of models in the database; and generating a result which indicates a likelihood of a similarity to the search criteria in the raster data. A system to perform the method is also described.

### CROSS-REFERENCE TO RELATED APPLICATIONS

This application claims priority to and the benefit of co-pending U.S. provisional patent application Ser. No. 61/647,547, SYSTEM FOR SEARCHING RASTER DATA IN THE CLOUD, filed May 16, 2012, which application is incorporated herein by reference in its entirety.

### FIELD OF THE INVENTION

The invention relates to automated media understanding systems and, more particularly, to a system and method for automatically searching for physical or graphical objects in video, images and raster data.

### BACKGROUND OF THE INVENTION

The number of solutions to the automated processing of video, images and raster data has grown significantly over the past 20 years. Numerous academic and patent documents have outlined approaches to various aspects of the problem. The central issue is that manual review is a poor solution to either live monitoring or forensic analysis of this data.

This technical area is characterized by systems targeted for automating the analysis of various subsets of raster data types/qualities, object types/qualities and operational scenarios. Frequently, no single system attempts to provide a framework for the predominant case, which is that, the aforementioned variables are not able to be controlled or anticipated. As a result, these so called legacy systems each perform their functions only in the context of limited data, objects and scenarios. With few exceptions, this has rendered the value of such legacy systems not high enough to gain significant acceptance, given the typically high cost of research and development. Legacy systems can be broken into four major groups; 1) Solutions developed to identify several object types in CCTV style video, which is common in ground based fixed structure video surveillance, 2) object specific solutions which focus upon recognition in a broader number of video types and scenarios, but which recognize a single or just a handful of pre-defined objects (e.g. faces, cars, license plates), 3) Systems which provide lower level image processing and basic motion detection capabilities in video, and 4) Systems focused upon various analysis of raster data which is not just RGB Video or Images.

### SUMMARY OF THE INVENTION

According to one aspect, the invention features a method which includes the steps of: providing a computer based raster data search system; providing raster data; providing one or more search models as a search criteria; receiving as input the raster data; transforming by computer the raster data into a mathematical representation of an appearance of the raster data; storing the mathematical representation of said appearance of the raster data as a set of models in a database; comparing by computer at least one search model to the set of models in the database; and generating a result which indicates a likelihood of a similarity to the search criteria in the raster data.

In one embodiment, the step of providing a raster data includes providing live raster data.

In another embodiment, the step of providing a raster data includes providing pre-recorded raster data.

In yet another embodiment, the step of providing at least one search model includes providing at least one search model for a search criteria selected from the group consisting of an object, an entity, and a target.

In yet another embodiment, the step of transforming by computer the raster data includes transforming by decomposing by computer the raster data into a set of models which represent the appearance of the raster data.

In yet another embodiment, the step of transforming by computer the raster data further includes transforming pixels into a dense indexed representation optimized for search.

In yet another embodiment, the step of transforming by computer the raster data further includes transforming the raster data into a mathematical representation which is optimized for a massively parallel search.

In yet another embodiment, the step of comparing by computer at least one search model to the set of models includes a measuring of a likelihood of similarity between example-based raster data models and a transformed raster search data.

In yet another embodiment, the step of generating a result which indicates a likelihood of a similarity to the search criteria in the raster data further includes spatio-temporal likelihoods.

In yet another embodiment, the step of providing at least one search model includes providing at least one search model for a search criteria which is sourced from one or more example raster data samples.

In yet another embodiment, the step of providing one or more search models further includes providing a mathematical model representing the appearance of a user selected entity to be searched for.

In yet another embodiment, the step of providing a raster data includes providing raster data selected from the group consisting of visible light video (RGB, YUV or similar), infrared video (IR), multi-spectral, hyper-spectral, LIDAR, sonar imagery, and RADAR Imagery.

In yet another embodiment, the step of generating a result further includes an ability to detect, or reject, single or multiple objects of interest depicted in the raster data.

In yet another embodiment, the step of generating a result further includes one or more user controls to dynamically adjust post-processed search results presented to a user in a client GUI through mathematical manipulation of a likelihood of similarity measure.

In yet another embodiment, the step of generating a result further includes one or more user controls to either increase a speed of search by reducing the accuracy of the search or to decrease the speed of search by increasing the accuracy of the search.

In yet another embodiment, one or more objects of interest are selected from the group consisting of physical objects, whole frames (temporal samples thereof) of raster data, multiple frames of raster data, and any arbitrary segment of raster data.

In yet another embodiment, the step of providing one or more search models for a search criteria further includes an updating of at least one search model by submission of one or more added raster data samples.

In yet another embodiment, the step of providing one or more search model for a search criteria further includes an updating of the at least one search model by use of a computer system graphical user interface (GUI) by a positive result feedback.

In yet another embodiment, the step of providing one or more search models further includes providing recognition to the system that a result was expected.

In yet another embodiment, the step of providing one or more search models for a search criteria further includes an updating of at least one search model by use of a computer system graphical user interface (GUI) by a negative result feedback.

In yet another embodiment, the step of providing one or more search models further includes providing feedback to the system that the result was unexpected.

In yet another embodiment, the step of providing a computer based raster data search system includes providing one or more clients configured to accept a user input via a user GUI, a host communicatively coupled to the one or more clients and communicatively coupled to one or more raster data processors, the host configured to maintain communication between the one or more clients and one or more raster data processors, the one or more clients and one or more raster data processors configured to process raster data as per instructions from the host.

In yet another embodiment, the step of providing a computer based raster data search system includes providing a scalable, massively parallel processing computer based raster data search system.

In yet another embodiment, the step of providing a computer based raster data search system includes providing a cloud based architecture including a Host, Client and Raster Data Processor.

In yet another embodiment, the cloud based architecture includes one or more hosts which are responsible for managing the processing of raster data.

In yet another embodiment, the cloud based architecture includes multiple clients which are responsible for accepting user input.

In yet another embodiment, the cloud based architecture includes multiple raster data processors which are responsible for processing the raster data.

In yet another embodiment, the cloud based architecture further includes an embedded architecture.

In yet another embodiment, the cloud based architecture further includes a data transfer protocol that facilitates communication of messages between elements of a cloud based implementation.

In yet another embodiment, the communication is selected from the group consisting of a command, raster data, transformed raster data, a mathematical model, a parameter, a status indicator and a node response.

According to another aspect, the invention features a system which includes a computer system configured to operate as a computer based raster data search system. The computer based raster data search system includes one or more clients configured to accept a user input via a user GUI. A host is communicatively coupled to the one or more clients. One or more raster data processors are communicatively coupled to the host. The host is configured to maintain communication between the one or more clients and the one or more raster data processors. The one or more clients and one or more raster data processors are configured to processes raster data as per instructions from the host. The computer based raster data search system is configured to receive as input raster data, to transform by computer said raster data into a mathematical representation of an appearance of said raster data, to store said mathematical representation of said appearance of said raster data as a set of models in a database, to compare by computer said at least one search model to said set of models in said database, and to generate a result which indicates a likelihood of a similarity to a search criteria in said raster data.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 shows a block diagram of one exemplary embodiment of the system;

FIG. 2 shows a block diagram of an exemplary Host of FIG. 1;

FIG. 3 shows a block diagram of an exemplary Client of FIG. 1;

FIG. 4 shows a block diagram of an exemplary Client GUI for the client of FIG. 3;

FIG. 5 shows a block diagram of an exemplary Raster Data Processor of FIG. 1;

FIG. 6 shows a block diagram of an exemplary Raster Data Processing Engine of FIG. 5;

FIG. 7 shows a block diagram of an exemplary Raster Data Transformation Engine of FIG. 6;

FIG. 8 shows a block diagram of an exemplary Transformed Raster Data of FIG. 7;

FIG. 9 shows a block diagram of an exemplary Raster Data Transformer of FIG. 7;

FIG. 10 shows a block diagram of an exemplary Raster Data Search Engine of FIG. 6;

FIG. 11 shows a block diagram of an exemplary Raster Data Search GUI of FIG. 10;

FIG. 12 shows a block diagram of an exemplary Model Builder GUI of FIG. 4;

FIG. 13 shows a block diagram of an exemplary Raster Data Search Results Manager of FIG. 10;

FIG. 14 shows a block diagram of an exemplary Client Message Manager of FIG. 2;

FIG. 15 shows a block diagram of an exemplary Client Action Performer of FIG. 14;

FIG. 16 shows a block diagram of an exemplary Raster Data Processor Message Manager of FIG. 2;

FIG. 17 shows a block diagram of an exemplary Raster Data Processor Action Performer of FIG. 16;

FIG. 18 shows a block diagram of an exemplary Forensic Search Configuration; and

FIG. 19 shows a block diagram of an exemplary Live Search Configuration.

### DETAILED DESCRIPTION

As described hereinabove, legacy systems focused upon CCTV style video are most common. Almost invariably, assumptions about the motion of the camera (the so called camera model), are employed to estimate the appearance of an otherwise static scene, or ‘background’. These models are typically affine in nature, whereby they do not support translation of the camera. Sub-segments of the video frame that do not follow the same motion characteristic of the camera, are said to be ‘foreground’. Contiguous pixel locations of foreground are frequently called ‘blobs’. These blobs, are typically evaluated for size and shape constraints to filter out noise effects. Obviously, specific academic or commercial offerings can vary significantly from one another, but generally share the above foreground/background ‘segmentation’ step, however it may be accomplished.

While the above outlined approaches can be applied to video taken from aircraft (birds eye view) to attempt the detection of moving objects, they are typically applied towards CCTV style video, with the intent of identifying a small subset of objects. Typically vehicles, full body humans and ‘left/stolen objects’ are the only supported. Blob size, either relative or absolute, coupled with blob shape, is frequently the most heavily relied upon discriminator. Vehicles are generally the largest objects detected. Humans tend to be taller than wide and are somewhat smaller than vehicles. Left objects are objects such as bags which are left in camera view, for a certain period of time, which are then declared ‘left’, and assimilated into the background appearance model. Stolen objects are objects which suddenly leave the camera view, revealing a prior occluded portion of the background. Again, after a predefined period of time, these objects are considered ‘stolen’.

Because of the assumptions outlined above, legacy systems perform predictably within a very limited set of raster data, objects and operational scenarios. Unfortunately, due to these same assumptions, if any of the above three variables shift outside of what the legacy system was originally designed to support, behavior will be unpredictable. While a complete review of this topic is beyond the scope of this description, several common problematic scenarios are summarized below.

Lighting changes which are clearly a common occurrence will cause the scene to appear different than it otherwise does, even if there are no moving objects in it. While there are lighting models which can be applied, there is not enough information in video itself to totally compensate.

Motion of the camera itself, if it does not obey the camera model, which is a common occurrence in many use cases, will cause errors in the estimation of the background and lead to erroneous objects being detected and classified. Further, if objects present are moving while the camera is moving, in certain conditions, the objects won't be detected, leading to false negatives. If the camera pans to see an object, the object will not be detected by the system until it starts moving. If it never starts moving while in view, it will not be detected at all. If two or more objects touch, or pass in front of one another, the larger blobs will frequently be mistaken for a single object, only to be again confused when the single object appears to split apart seconds later.

Legacy systems with object specific models, approach the problem differently. Explicit modeling of camera motion and the scene are infrequent, where the systems rely upon prior trained models to gross search every portion of the video/image plane for that object. Both the systems for modeling of the specific objects, and the subsequent use of those models for identification or classification of objects can vary significantly. Most object modeling approaches are heavily data driven, requiring vast repositories of training data which are labeled manually to provide ground truth instances from which models may be trained. Due to the laborious nature of the ground truth data generation, these approaches typically focus upon a single object or a small subset of objects for recognition and classification, such as faces, vehicles, or vehicle license plates.

These legacy systems are clearly limited in their ability to identify the broad swath of objects that any user may seek to identify. Further these systems are typically finely tuned and targeted for specific applications which lends them to not be able to support a generic modeling and search system. Clearly these systems can only analyze video or images of the quality or type for which they were originally trained on. One can achieve greater breath in operational scenario, object support, or data types/qualities if one employs multiple systems. Of course, doing so requires reprocessing the video multiple times, and also requires combining the results of multiple disparate systems, the result of which is an aggregate system which without doubt has a very unintuitive operational characteristic.

Several approaches referenced in this description have sought to supplement searches of video or images with common text based mining techniques. In some cases, this can reduce user frustration, as they may understand why they system returned in appropriate results (e.g. the filename indicated content that wasn't there). Nonetheless, the ‘actual’ results will worsen, unless the original video/image based recognition is sub-adequate to begin with.

Analyses of other forms of raster data, such as LIDAR or Hyperspectral imagery, have been the target of other systems. Typically conventional approaches, outlined in the paragraphs above, have been modified to operate on this type of data. Naturally the same problems and pitfalls continue to exist.

Overall, the legacy systems reviewed in this section suffer from specific problems in an operational sense, leading generally to user dissatisfaction or inefficiency. While the core technology solutions suffer from specific problems, lack of an ability to perform at many times real-time, coupled with the fact that there is no built in ability for the user to cooperate with the system in the recognition task is the largest source of user alienation. If users are provided an ability to actively mitigate mistakes made by the systems users will be more satisfied with the solutions, and the results generated will be of higher quality.

The acquisition and production of video/image/raster data has exploded, whereby the rate of growth is increasing by all producers (individuals, corporations and governments). Quick access to production tools online has made it possible for individuals to produce video at rates reserved for corporate entities only ten years prior. Companies acquire and produce ever increasing amounts of this data for security, market intelligence and advertising purposes. Governments have a multitude of options for acquiring more and more video/image/raster data through smaller, cheaper, and higher quality cameras and raster data sensors.

Despite the growth of the amount of video, current state of the art in examination of general video/images/raster data is manual. This is despite the fact that humans are quite limited in their ability to review this data. Forcing increases in the rate of manual review instigates significant performance degradation, such that results rapidly become worse than chance, and thereby useless. Without increases in the rate of review, the amount of video that is able to be reviewed is but a fraction of that which is acquired and stored.

The quality of raster data varies dramatically and in many different capacities. Many past and current methods for automatic information extraction from this data must be employed to identify a very limited set of objects or phenomenon in a limited set of data types and qualities. So in order to analyze a set of data containing many disparate types and qualities with these legacy systems, different automated systems are required. This is problematic for several reasons, which are described below.

Legacy systems, considered individually, do not behave in ways that are intuitive to the user. It is understandable to users that objects occasionally might not be seen clearly, or if very small, may not be detected with great degrees of confidence by an automated system. It is not intuitive to users that the ‘behavior’ of the object (object moving/not moving/moving slowly/coming close to another object) will adversely affect performance when the object is in plain view and with abundant data quality. Legacy systems will perform predictably for several operational scenarios, only to rapidly degrade into random results if the operational scenario changes, seemingly only slightly.

Further, each legacy automated system has drastically different error functions and operating characteristics than other automated systems. Combination of the results of many systems such as this is extremely problematic, even if the combination is appropriately handled from a mathematical point of view. The problems stem from the fact that the behavior of the aggregate system will change unpredictably and seemingly erratically to the user. If the user is led to distrust the output of the aggregate system, they will not come to rely upon it as a useful tool.

Finally, legacy systems are not much faster at processing video than a few times real time. Lack of legacy system speed is largely due to the underlying algorithms being exceptionally hard to implement in a MPP (Massively Parallel Processing) paradigm. Given the amount of video in need of analysis, the solution required must process at least at 2 orders of magnitude (100×) real-time to meet minimum operational requirements for almost all uses of video outside of consumption for pure human entertainment.

Now turning generally to the computer based raster data search system, a computer based method for automatically processing raster data, which includes but is not limited to, visible light video (RGB, YUV or similar), IR (Infrared video), Multi-Spectral, Hyper-Spectral, LIDAR, Sonar Imagery, Radar Imagery is described hereinbelow. The method includes transforming of raster data into a dense and efficient mathematical representation which can be optimized for massively parallel search. Raster data examples can be transformed into a mathematical model representing the appearance of a user selected entity to be searched. Raster data examples can also be transformed into a mathematical model representing the appearance of a user selected entity to be searched. As described hereinbelow in more detail, a likelihood of similarity between example-based raster data models and transformed raster search data can be measured. Also, a likelihood of similarity between example-based raster data models and transformed raster search data can be measured. The likelihood of similarity measures can be used to generate search results. There can also be an ability to detect, or reject, single or multiple objects of interest depicted in raster data, which includes but is not limited to; physical objects, whole frames (temporal samples thereof) of raster data, multiple frames of raster data, any arbitrary segment of raster data. The ability to detect, or reject can include changes in scenes or produce ‘story of life’ reports based upon amalgamated search models. There can also be an updating of search models with the system GUI (Graphical User Interface), by the following methods, but not limited to; submission of added raster data samples, positive result feedback (e.g. providing recognition to the system that the result was expected), negative result feedback (e.g. providing feedback to the system that the result was unexpected). There can also be an ability provided to the user through single or multiple control(s) to dynamically adjust post-processed search results presented to the user in the client GUI, through mathematical manipulation of the likelihood of similarity measure. There can also be an ability through single or multiple control(s) to allow the user to increase the speed of search by reducing the accuracy of the search and vice-versa. The design and implementation of such a system can adhere to a completely MPP (Massively Parallel Processing) paradigm, which enables theoretically infinite scale to the system. Implementations of the system and method described herein can include a cloud based architecture, namely, a Host, Client and Raster Data Processor, whereby; there may be multiple hosts which are responsible for managing the processing of raster data, there may be multiple clients which are responsible for accepting user input and displaying system output, and there may be multiple raster data processors which are responsible for processing the raster data. Implementations can include an embedded architecture, namely, implementation of the functions of the system, or some subset, on embedded processors. Implementation can also include a data transfer protocol that facilitates communication of messages between the all elements of cloud based implementation, which includes but is not limited to; commands, raster data, transformed raster data, mathematical models, parameters, status indicators and node responses.

The computer based raster data search system described herein is capable of detecting and classifying objects represented in raster data by examples from other sources of raster data submitted by users. Users can create models to search with through a GUI (Graphical User Interface), which is part of this system. The search model is used the search input video, images or other raster data in a completely MPP (Massively Parallel Processing) paradigm. This enables the system to operate with great speed on single computers and also be readily scalable to many computers.

The system is broken into two main phases, a ‘transformation phase’, and a ‘search phase’. The ‘transformation phase’, transforms any raster data that the user desires to be searched into a dense set of models which represent the ‘appearance’ of the raster data. The ‘search phase’ employs search models, created and submitted by the user, to search the transformed raster data.

Users create search models by submission of one or more example data samples. Upon returning search results, the users may further update search models, by providing feedback on the search results. They provide this feedback by declaring a search result as ‘false positive’ or a ‘true positive’. In the case of ‘false positive’ user determinations, the system will adjust search models to not return results similar to the ‘false positive’ result. In the case of ‘true positive’ user determinations, the system will adjust search models to more favor signatures which appear similar to the ‘true positive’ result. More example data may be added or subtracted from any search model.

The system maintains a cloud amenable, multi-user, multi-threaded architecture, whereby many users can use the system's client GUIs to communicate with host processes which manage the processing executed by many raster data processing units. This cloud based architecture allows the system to be flexibly deployed in very centralized environments, semi-centralized environments, local environments and anything in between.

### Example

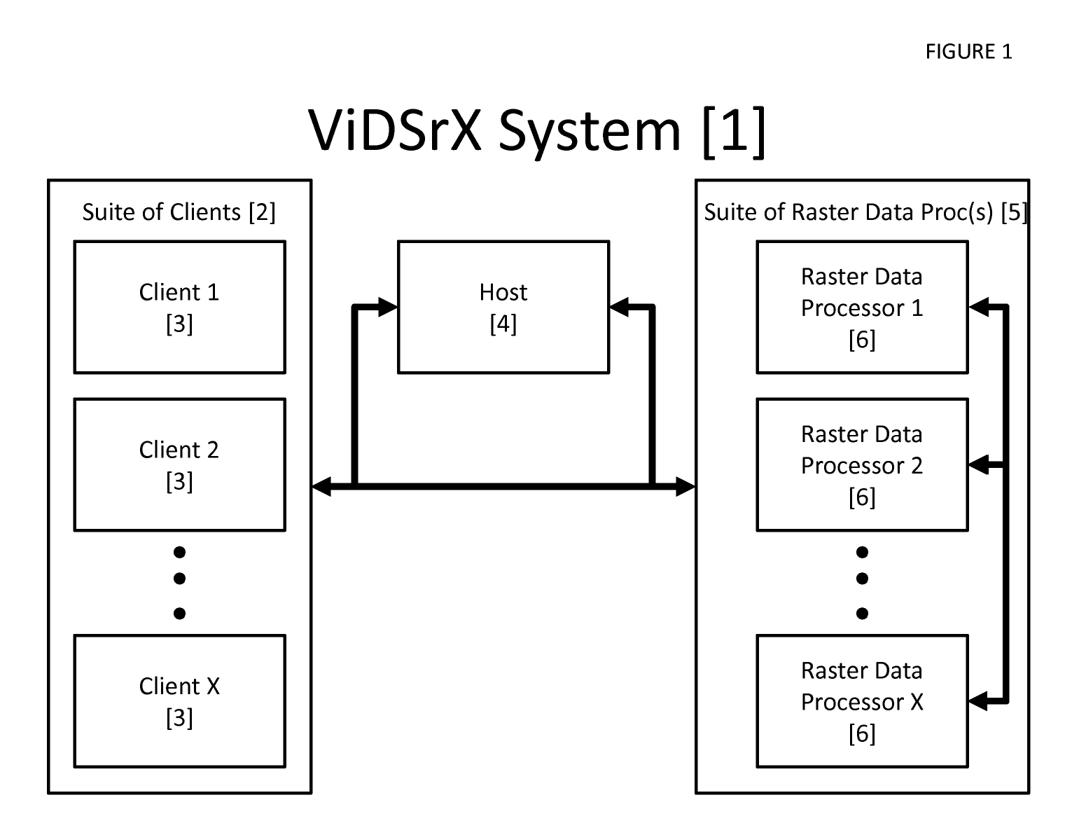

FIG. 1 shows one exemplary embodiment of a computer based raster data search system. The cloud based raster data search system, hereafter called the ViDSrX System 1, is functionally outlined in the accompanying systems diagrams. The ViDSrX System 1 is outlined in a high level functional diagram in FIG. 1. It can be seen that the system supports multiple clients 2 and assumes a Suite of Raster Data Processors 5. The Host 4, depicted in the center of the diagram, may be made up of one or many physical or virtual computers, and performs all coordination of client requests and raster data processing. As such, the Host 4 maintains direct communications with all active Clients 3 and Raster Data Processors 6. Each Client 3 is responsible for receiving instructions and delivering system responses from and to the User. Each Raster Data Processor 6 is responsible for processing raster data as per instructions from the Host 4.

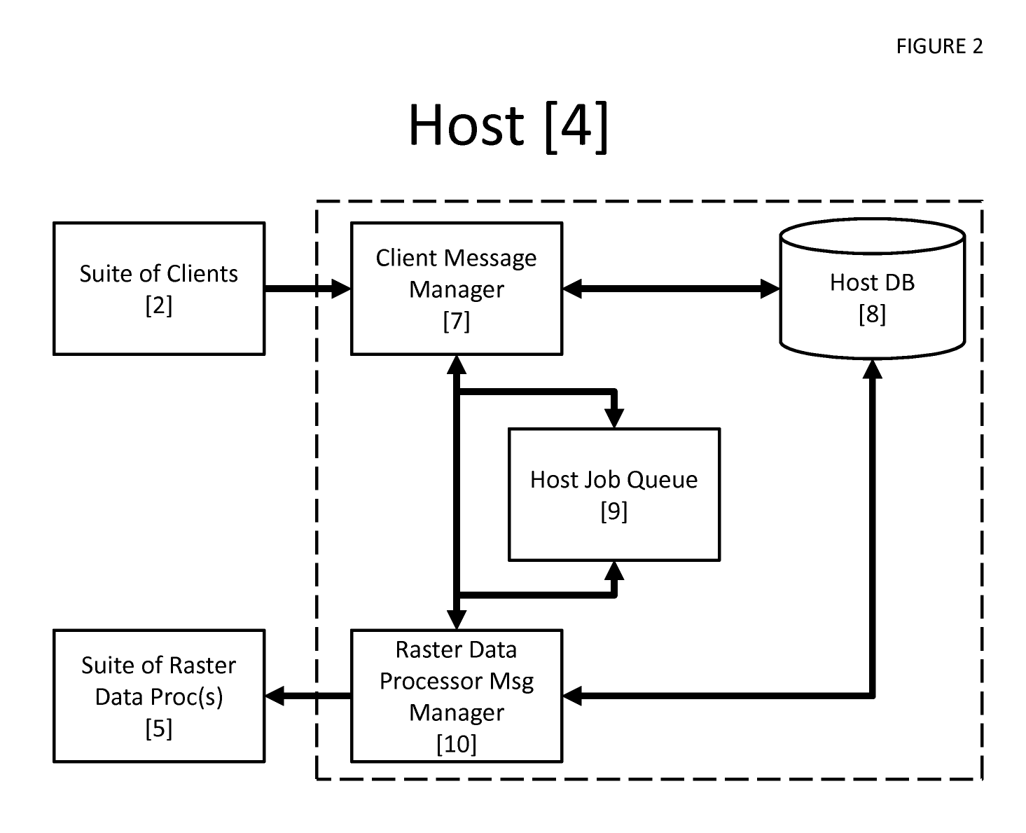

FIG. 2 shows an exemplary Host 4 of the system, which coordinates all data processing. In FIG. 2, the function of the Host 4 is outlined with greater detail. Messages from the Clients 3 are received by the Client Message Manager 7, which in turn issues processing jobs to the Host Job Queue 9, and in some cases directly to the Raster Data Processor Message Manager 10, in coordination with information received from the Host DB (Database) 8. The Host DB 8 stores all resources, actions and other communication of and within the system. The Host Job Queue 9 is responsible for buffering backlogs of job requests, where the rate of requests exceeds the ability of the Suite of Raster Data Processor's 5 ability to keep up. The Raster Data Processor Message Manager 10 is responsible for sending processing jobs to the Suite of Raster Data Processors 5.

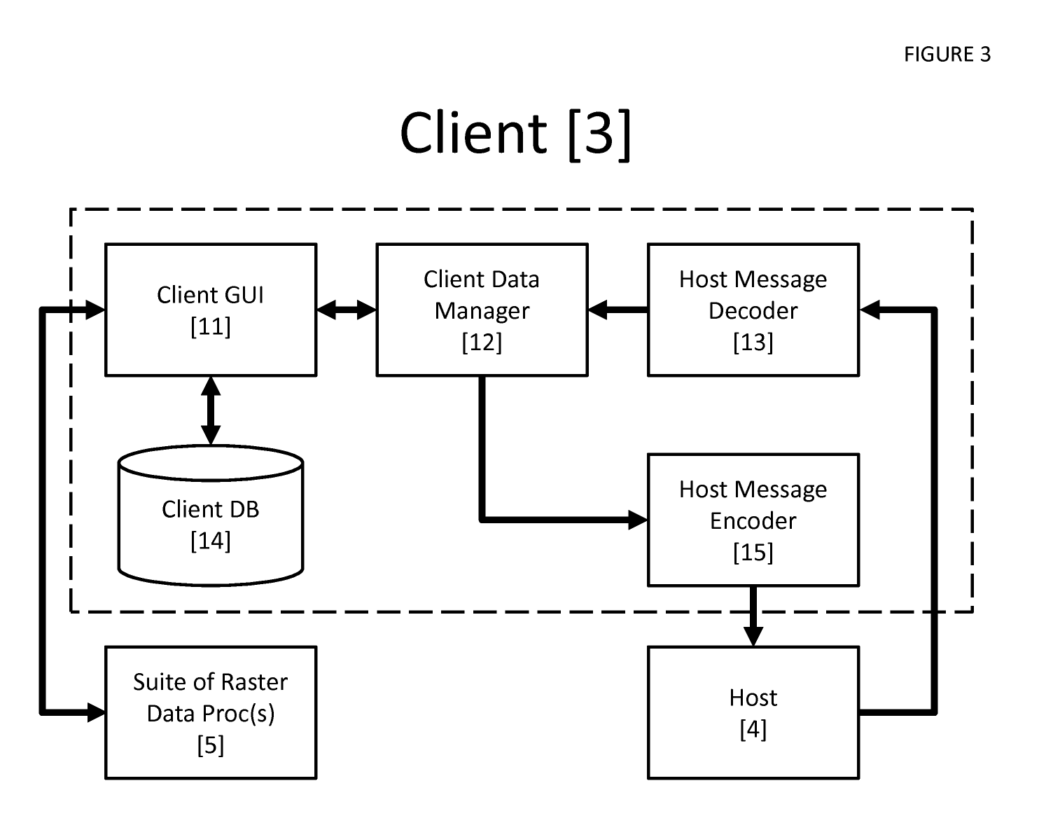

FIG. 3 shows an exemplary Client 3, of which there may be many for any given system, is what the user employs to control and manage data processing. In FIG. 3, the Client 3 is functionally outlined. The Client GUI 11 is the graphical user interface which is exposed to the user, whereby all commands from the user are received and responses from the system are displayed. It coordinates with the Client Data Manager 12, which manages all client specific data, and the Client DB (Database) 14, which stores all client specific data. The Client Data Manager 12 receives and sends messages from the Host Message Decoder 13 and the Host Message Encoder 15, respectively, in order to communicate with the Host 4. The Suite of Raster Data Processors 5 communicates directly with Client GUI in order to provide search results as quickly as possible, and also to enable any subsequent user modification of those search results.

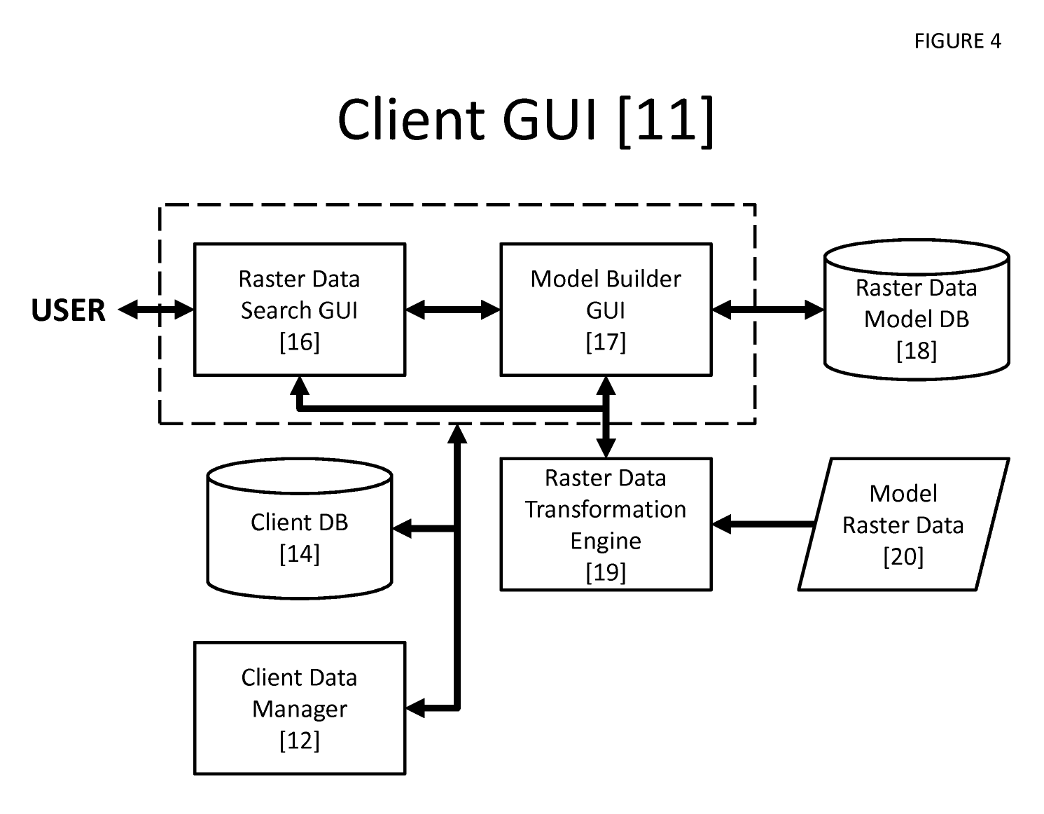

FIG. 4 shows an exemplary Client GUI 11, a user interface within the Client 3. It can be seen that the user interacts directly with the Raster Data Search GUI 16 which is used to provide video, images and raster data to the system, providing commands for processing of that data through the Raster Data Transformation Engine 19, and general administration of system project files, which connect settings, data and search results into a single repository located in the Client DB 14, through the Client Data Manager 12. The Raster Data Search GUI 16 also provides access to the Model Builder GUI 17, which allows users to load and display video, images and raster data, crop and annotate that data to format object examples, and to enter other information pertinent to the formation of object models. The Model Builder GUI 17 leverages the Raster Data Model Database 18 to store all model associated data and information. The Raster Data Transformation Engine 19, at the direction of the Model Builder GUI 17, performs all processing required for generation of the models from the Model Raster Data 20.

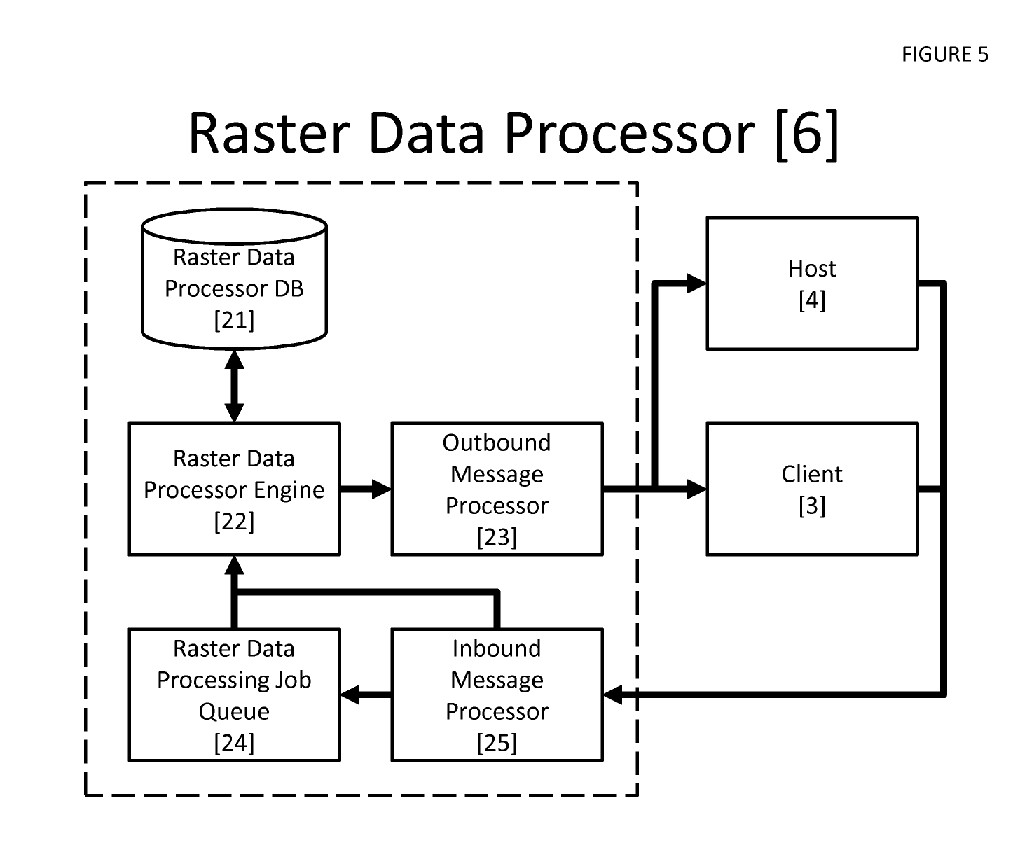

FIG. 5 shows an exemplary Raster Data Processor 6, of which there may be many for any given system, organizes and performs the data processing. The Raster Data Processor Engine 22 is the central control block of the system responsible for all management and execution of raster data processing. It updates and reads from the Raster Data Processor DB 21 which stores all transformed video/images/raster data, any settings, configurations or state information, and some search results. The Outbound Message Processor 23 is directed by the Raster Data Processor Engine 22 to format and encode any messages to the Clients 3 or Hosts 4. The Inbound Message Processor 25 is employed by the Raster Data Processor Engine 22 to format and decode any messages from the Clients 3 or Hosts 4. Any inbound messages indicating processing jobs are funneled to the Raster Data Processing Job Queue 24 which buffers requests for processing which the Raster Data Processor Engine 22 manages and executes.

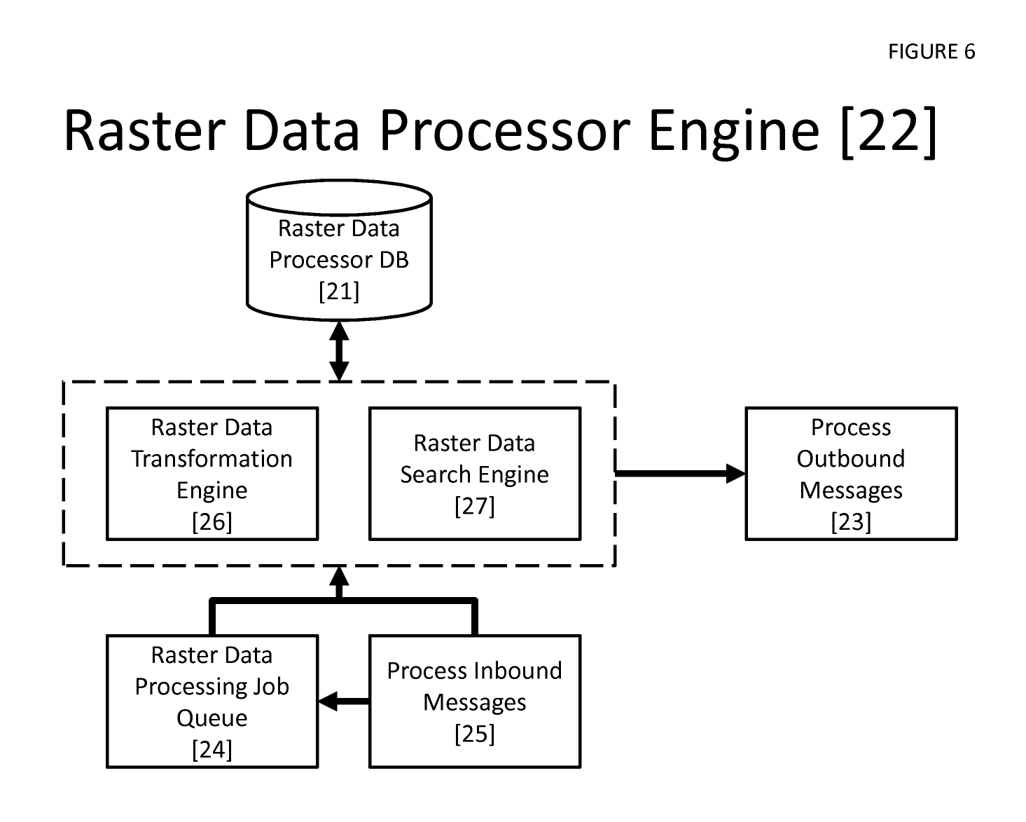

FIG. 6 shows an exemplary Raster Data Processing Engine 22, a part of the Raster Data Processor 6, which performs the data processing. FIG. 6 outlines that the underlying function of the Raster Data Processor Engine 22 is embodied by two separate blocks; the Raster Data Transformation Engine 26 and the Raster Data Search Engine 27.

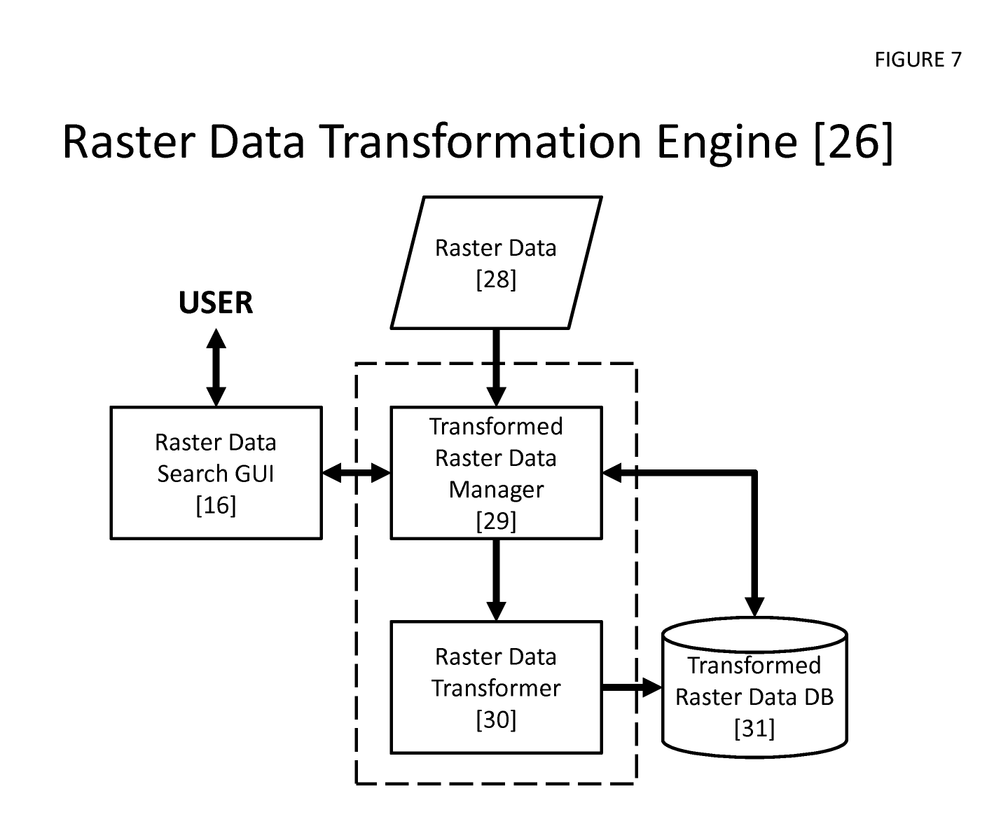

FIG. 7 shows an exemplary Raster Data Transformation Engine 26, a part of the Raster Data Processing Engine 22, which manages and performs the transformation of pixels into a dense indexed representation, optimized for search. FIG. 7 depicts the functional diagram of the Raster Data Transformation Engine 26. The Transformed Raster Data Manager 29 manages all transformation of Raster Data 28, by taking command and providing feedback from and to the Raster Data Search GUI 16, by coordinating the processing of Raster Data 28 by the Raster Data Transformer 30, and by reading and writing results to the Transformed Raster Data DB 31. The Raster Data Transformer 30 is responsible for transforming all Raster Data 28 which is to be searched or used to form object models. The Transformed Raster Data DB 31 is responsible for storing all transformed data, and models which are created on that particular Raster Data Processor 6.

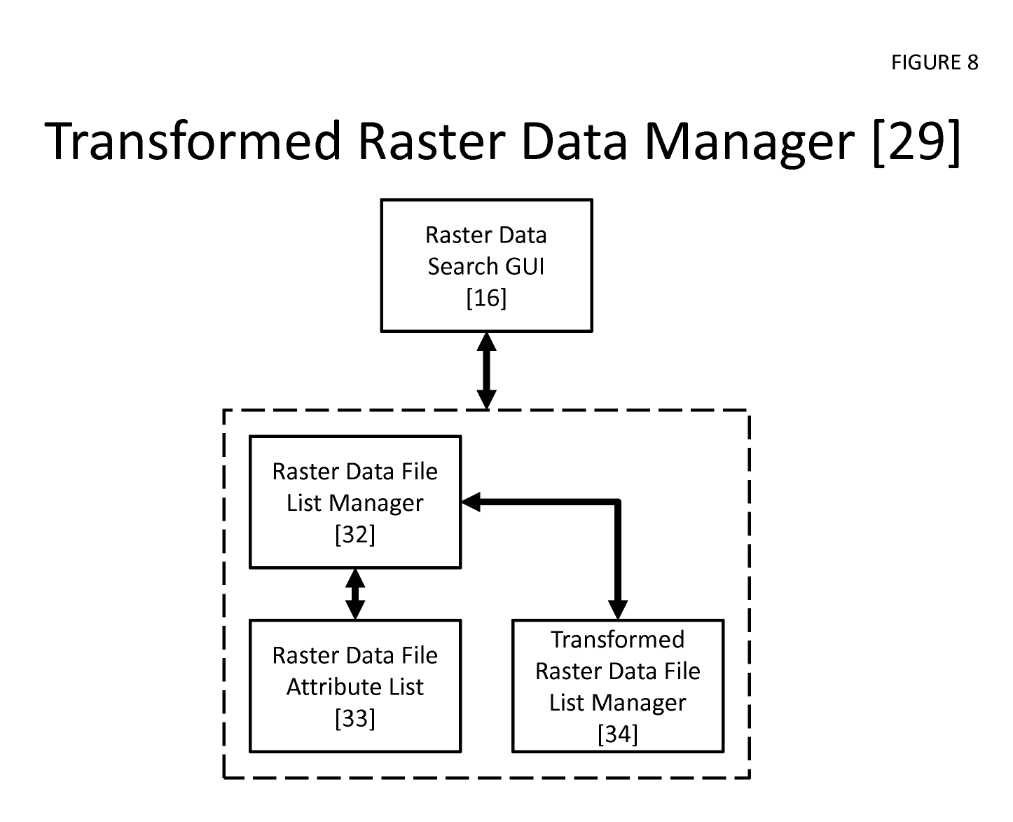

FIG. 8 shows an exemplary Transformed Raster Data Manager 29, a part of the Raster Data Transformation Engine 26, which manages, organizes and performs higher level processing to support the Raster Data Transformer 30. As seen in FIG. 8, which outlines the Transformed Raster Data Manager 29, the Raster Data File List Manager 32 manages the various locations and names of the Raster Data 28 associated with a particular Raster Data Processor 6. The Raster Data File List Manager 32 coordinates with the Transformed Raster Data File List Manager 34, which manages all salient information regarding the transformed raster data, and the Raster Data File Attribute List, which manages settings, configurations and metrics related to the original raster data.

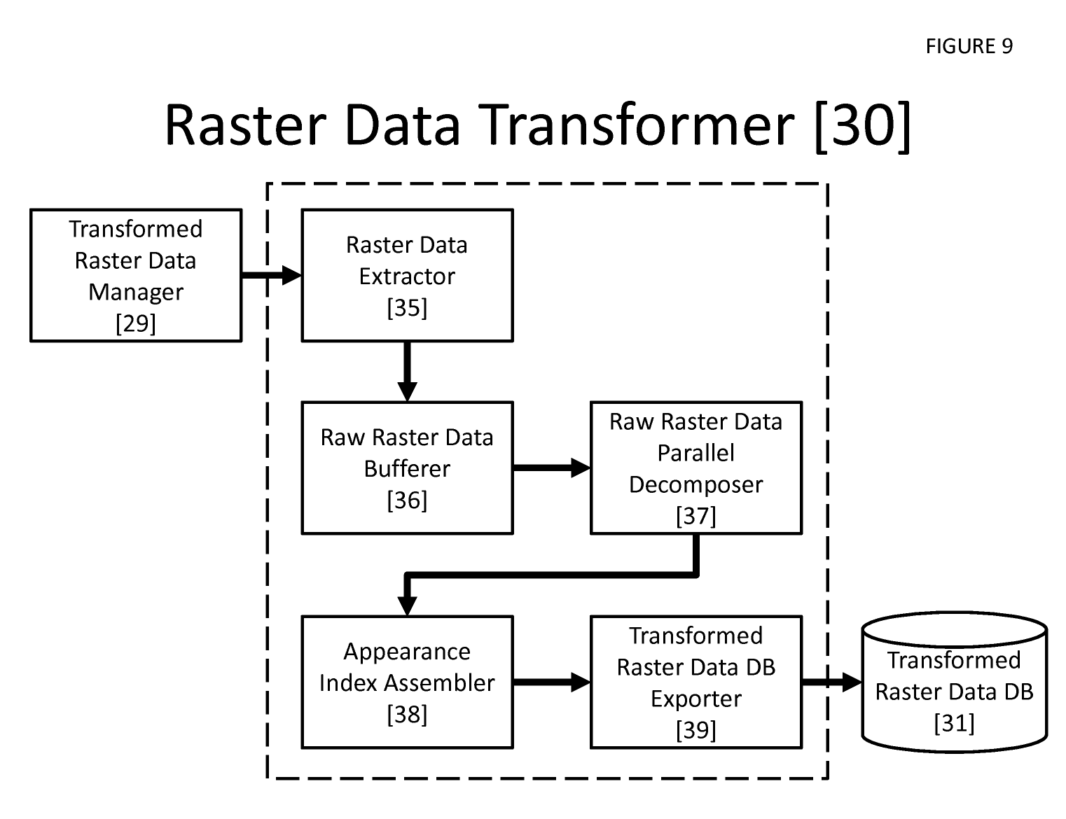

FIG. 9 shows an exemplary Raster Data Transformer 30, a part of the Raster Data Transformation Engine 26, which performs the transformation of pixels into a dense indexed representation, optimized for search. The Raster Data Transformer 30 is outlined in FIG. 9. Herein, the Raster Data Extractor 35 receives commands and data from the Transformed Raster Data Manager 29, in-turn providing the Raw Raster Data Bufferer 36, extracted data which it buffers for subsequent processing. The Raw Raster Data Parallel Decomposer 37 receives extracted data which it decomposes into a set of mathematical models which model and describe the appearance of the raw raster data. The Appearance Index Assembler 38 compiles, condenses and organizes the decomposed raster data from the Raw Raster Data Parallel Decomposer 37. The Transformed Raster Data DB Exporter 39 exports all transformed raster data to the Transformed Raster Data DB 31, where it is stored for future use.

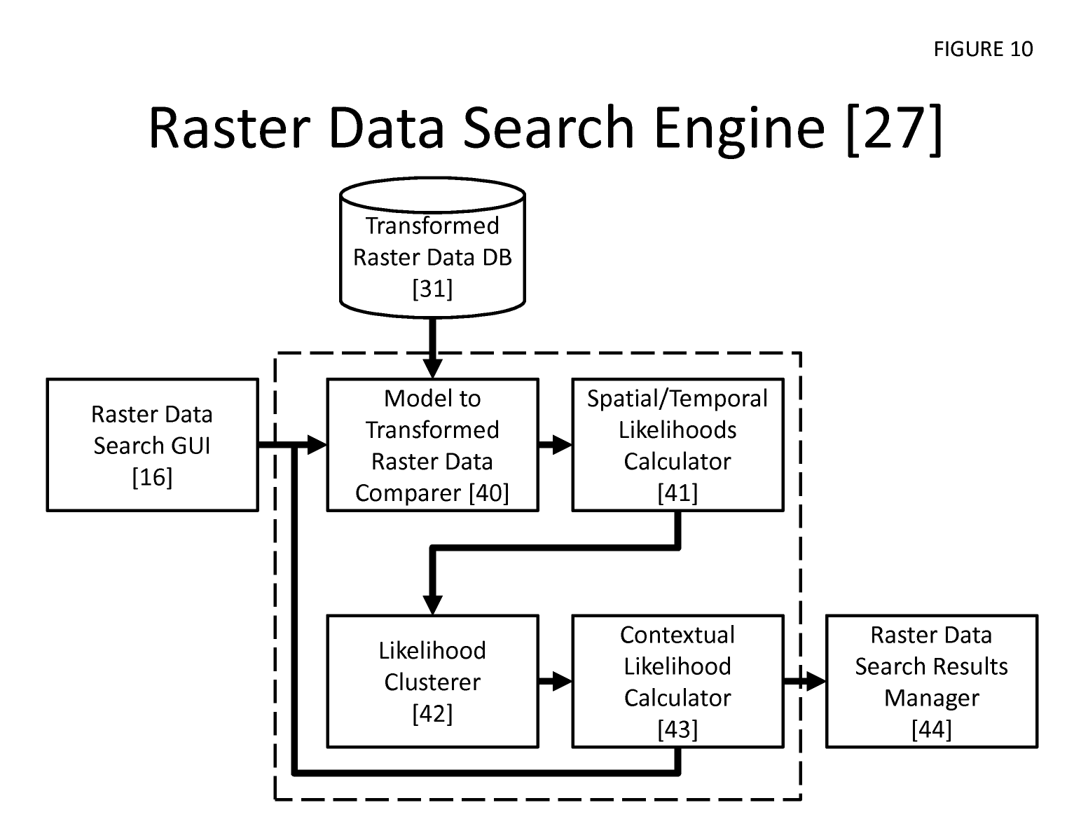

FIG. 10 shows an exemplary Raster Data Search Engine 27 which manages and performs the search function by comparing model data to the transformed raster data in order to generate search results. The Model to Transformed Raster Data Comparer 40 is directed by the Raster Data Search GUI 16 to compare the similarity of portions of the transformed raster data, stored in the Transformed Raster Data DB 31, to the raster data models which are stored in the Raster Data Model DB 18. The results of the comparison(s) are a set of spatio-temporal measures which are funneled to the Spatial/Temporal Likelihoods Calculator 41 which transform the spatio-temporal measures into spatio-temporal likelihoods. The spatio-temporal likelihoods are then clustered by the Likelihood Clusterer 42, which in turn provides the clustered data to the Contextual Likelihood Calculator 43, which generates likelihoods for a variety of raster data types/qualities, object types/qualities and operational scenario contexts. This information is provided to the Raster Data Search Results Manager 44.

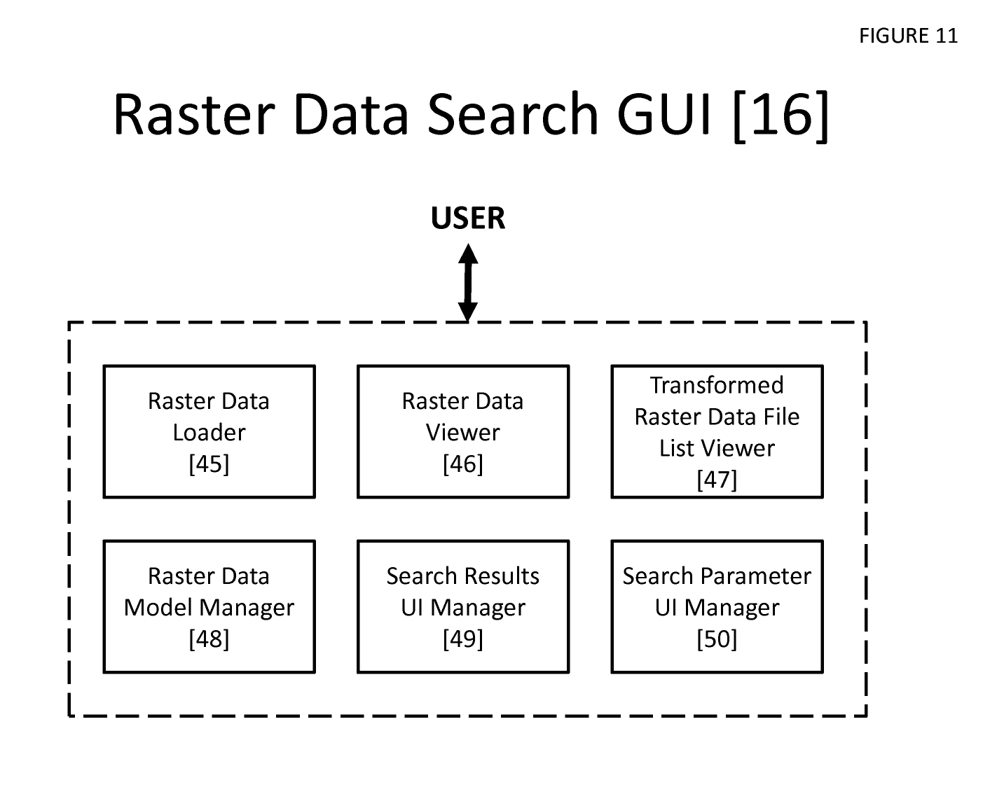

FIG. 11 shows an exemplary Raster Data Search GUI 16 which manages and performs the user interface tasks involving receipt of user input information and displaying output information The Raster Data Search GUI 16 is depicted in FIG. 11, where it can be seen the many parallel functions centering upon receiving and displaying information from and to the user is the core function. The Raster Data Loader 45 allows the user to load a wide range of raster data files and formats. The Raster Data Viewer 46 displays to the user what the raster data looks like, and allows the user to scan through it temporally, where the data has a temporal component, and to zoom and pan within the raster data, where adequate scale and resolution exist. The Transformed Raster Data File List Viewer 47 allows the user to view and edit the list of files which indicate the type and location of the raster data, which have been or will be transformed by the system. The Raster Data Model Manager 48 manages the loading, storage and creation of the object models used to search the raster data. The Search Results UI Manager 49 renders the proper information for display to the user, and accepts/responds to user input regarding the following, but not limited to; confirmation of true positive identification, confirmation of false positive identification, altering of any variables affecting the display of these, or similar, results through dynamic or static controls. The Search Parameter UI Manager 50 is a console of static and dynamic thresholds which control the nature of the search. They include, but are not limited to; a filter parameter which dynamically filters output likelihoods on a per object basis, a dynamic threshold of acceptance that allows the user to dynamically balance true and false positive rates, a speed threshold which allows the user to balance the speed of processing with accuracy, and a level of detail setting that provides for the ability to balance between the amount of transformed raster data produced and the minimum size of the objects to be detected. In the exemplary embodiment, all of the aforementioned variables are controlled by use of slide bar, absolute number accepted by though a text box, or through any common user interface control.

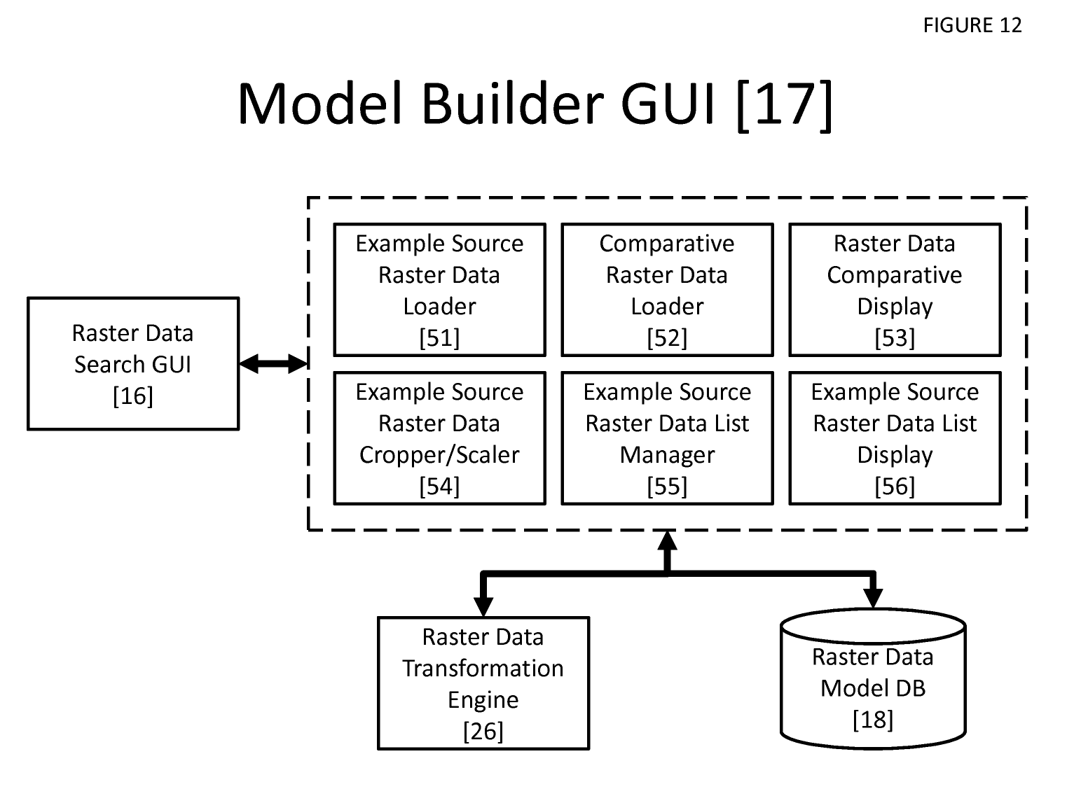

FIG. 12 shows an exemplary Model Builder GUI 17 which allows the user to build search models from search criteria which are sourced from example raster data samples, similar to the search target. Outlined in FIG. 12, the Model Builder GUI 17 provides the user an ability to quickly and dynamically build object models used for subsequent searches, and is accessible through the Raster Data Search GUI 16. The Example Source Raster Data Loader 51 provides the user the ability to load any type of raster data for use as source examples to be provided to the system for modeling purposes. The Comparative Raster Data Loader 51 allows the user the ability to load data which may represent data similar to some or all of the raster data to be searched, such that the user may subsequently, manually inspect the similarities between source data and the data to be searched by use of the Raster Data Comparative Display 53. The Example Source Raster Data Cropper/Scaler 54 affords the user the ability to crop any segment of the source raster data indicating the object(s) to be searched for which includes but is not limited to the entire body of source raster data or any sub-portion thereof. It also allows the user to subsequently scale the size of the cropped source raster data to any scale either larger or smaller, either spatially or temporally. In the exemplary embodiment, all modifications and source information associated with the source raster data are managed by the Example Source Raster Data List Manager 55. The Example Source Raster Data List Display 56 provides display feedback mechanisms for all of the aforementioned data and functionality. The Model Builder GUI 17 leverages directly the Raster Data Transformation Engine 26 to create the models based upon input from the user, and employs the Raster Data Model DB 18 for all storage of the models.

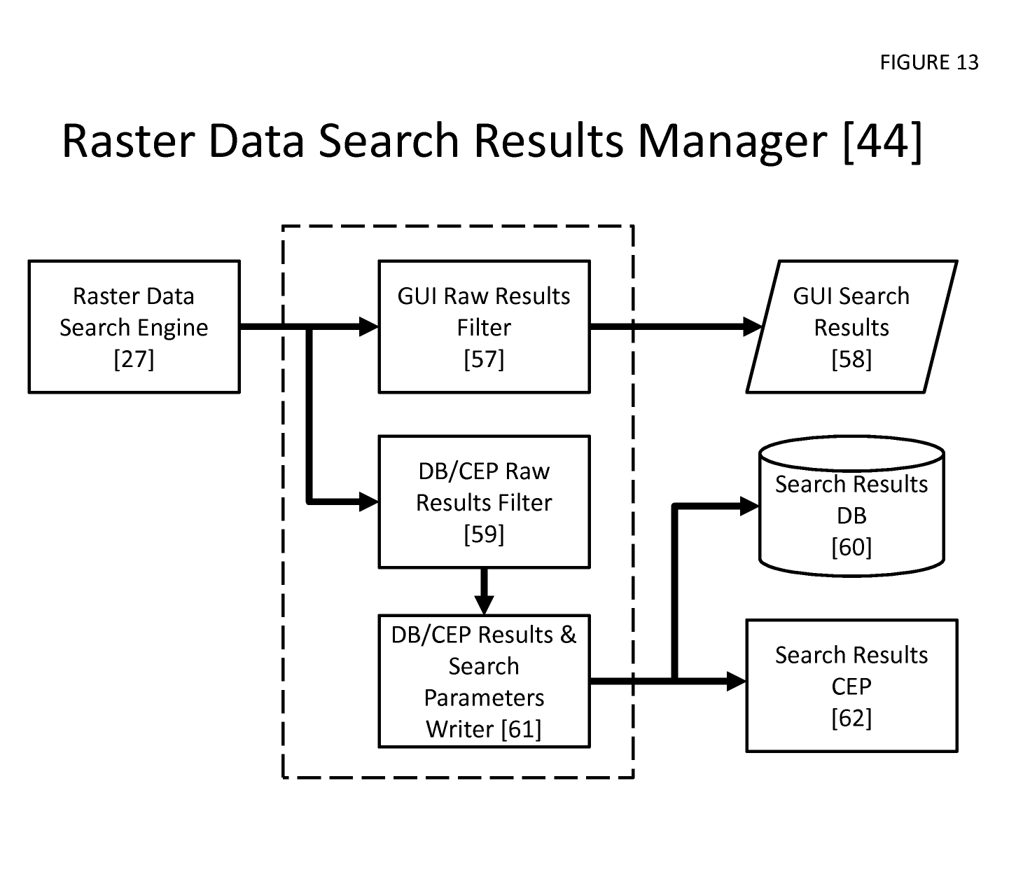

FIG. 13 shows an exemplary Raster Data Search Results Manager 44 which manages the receipt and filtering of search results for storage, transmission and display to the user. In FIG. 13, the Raster Data Search Results Manager 44 is depicted. Search results generated by the Raster Data Search Engine 27 are provided to the GUI Raw Results Filter 57 which applies one or many filters to the raw results to reduce noise and to make the results more appealing/understandable for purposes of display of the GUI Search Results 58 to the user GUI. Search results are also forwarded to the DB/CEP Raw Results Filter 59 which applies one or more, of the same, similar or dissimilar, filters discussed above to format, and make most amenable, the results for deposit for long or short term storage in a database, or for delivery to a CEP (Complex Event Processor). The DB/CEP Results & Search Parameters Writer 61 accepts the filtered results from the DB/CEP Raw Results Filter 59 and writes them to a stream for the Search Results CEP 62 and/or to Search Results DB 60.

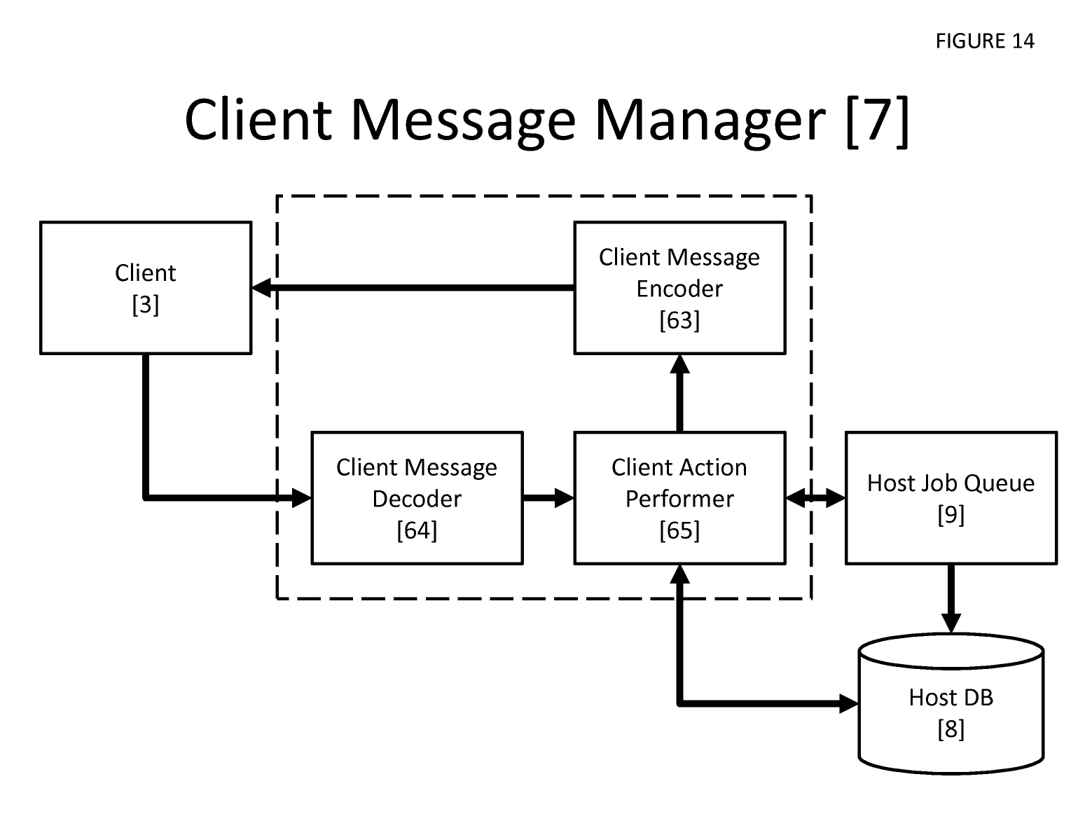

FIG. 14 shows an exemplary Client Message Manager 7, a part of the Host 4, which manages messaging to and from the Client 3. The Client Message Manager 7, outlined in FIG. 14, is part of the Host 4 and is responsible for communication with the Client 3. The Client Message Encoder 63 encodes messages generated by the Client Action Performer 65 for delivery to the Client 3. The Client Message Decoder 64 is responsible for decoding messages to the Client Action Performer 65. The Client Action Performer 65 coordinates with the Host Job Queue 9 and the Host DB 8 in order to manage communication within the Host 4.

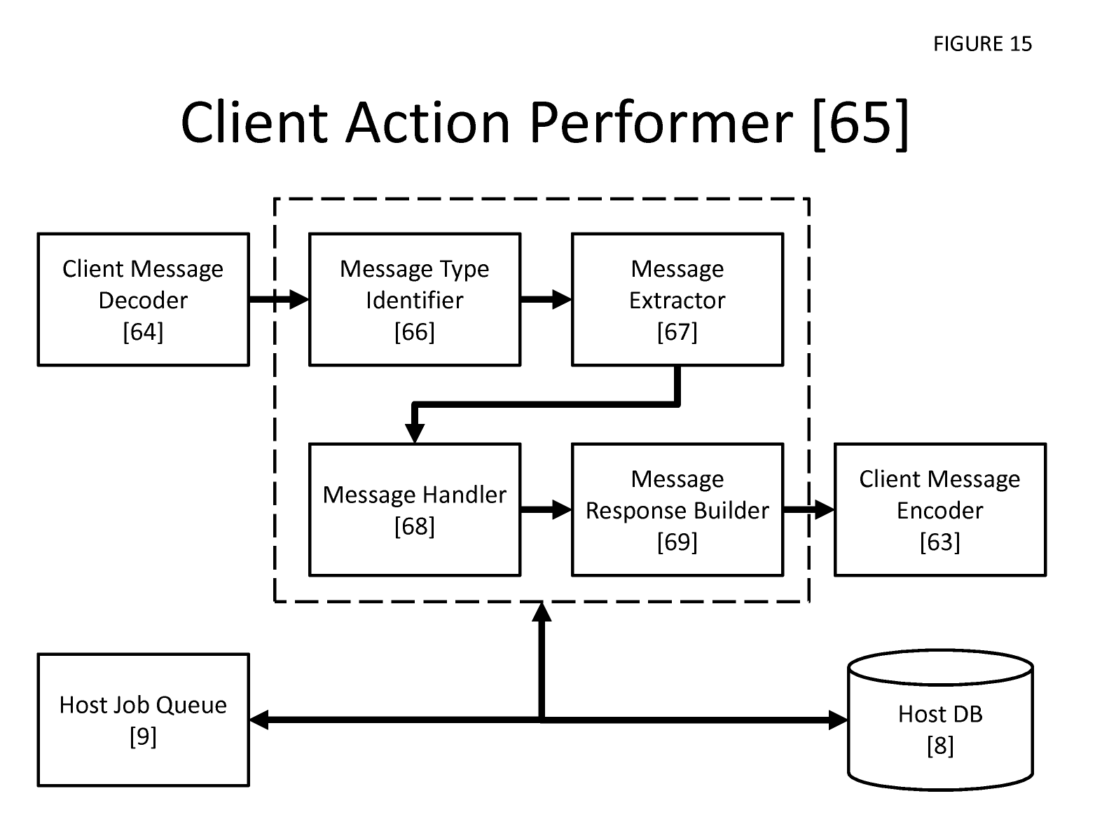

FIG. 15 shows an exemplary Client Action Performer 65, a part of the Client Message Manager 7, which interprets, executes and provides feedback on messages, sent to the Host 4, from the Client 3. In FIG. 15, the function of the Client Action Performer 65 is further defined, where the Message Type Identifier 66 identifies the nature of the client message and provides it to the Message Extractor 67, which unpacks the message into the message format employed internally in the Host 4. The Message Handler 68 receives this unpacked message, coordinates as applicable with the Host Job Queue 9 and the Host DB 8, and sends the resulting message with annotation, as appropriate, to the Message Response Builder 69. The Message Response Builder 69, in turn, generates a response to the message which is delivered for encoding to the Client Message Encoder 63.

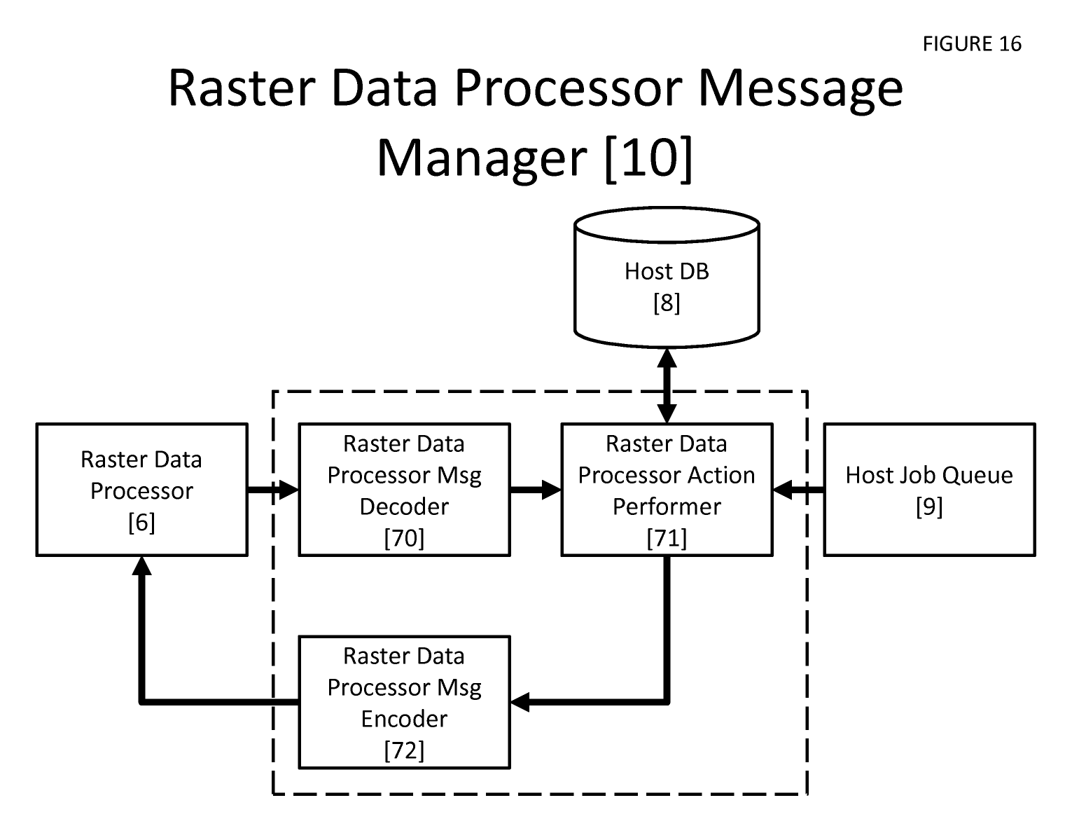

FIG. 16 shows an exemplary Raster Data Processor Message Manager 10, a part of the Host 4, which manages messaging to and from the Raster Data Processor 6. The Raster Data Processor Message Manager 10, depicted in FIG. 16, is a part of the Host 4 which is responsible for communication with the Raster Data Processor 6. The Raster Data Processor Message Decoder 70 decodes messages received from the Raster Data Processor 6 and forwards the decoded messages to the Raster Data Processor Action Performer 71. The Raster Data Processor Action Performer 71 is responsible for coordinating with the Host DB 8 and the Host Job Queue 9 in order to process incoming and outgoing messages to and from the Raster Data Processor 6. The Raster Data Processor Message Encoder 72 is responsible for encoding outgoing messages to the Raster Data Processor 6.

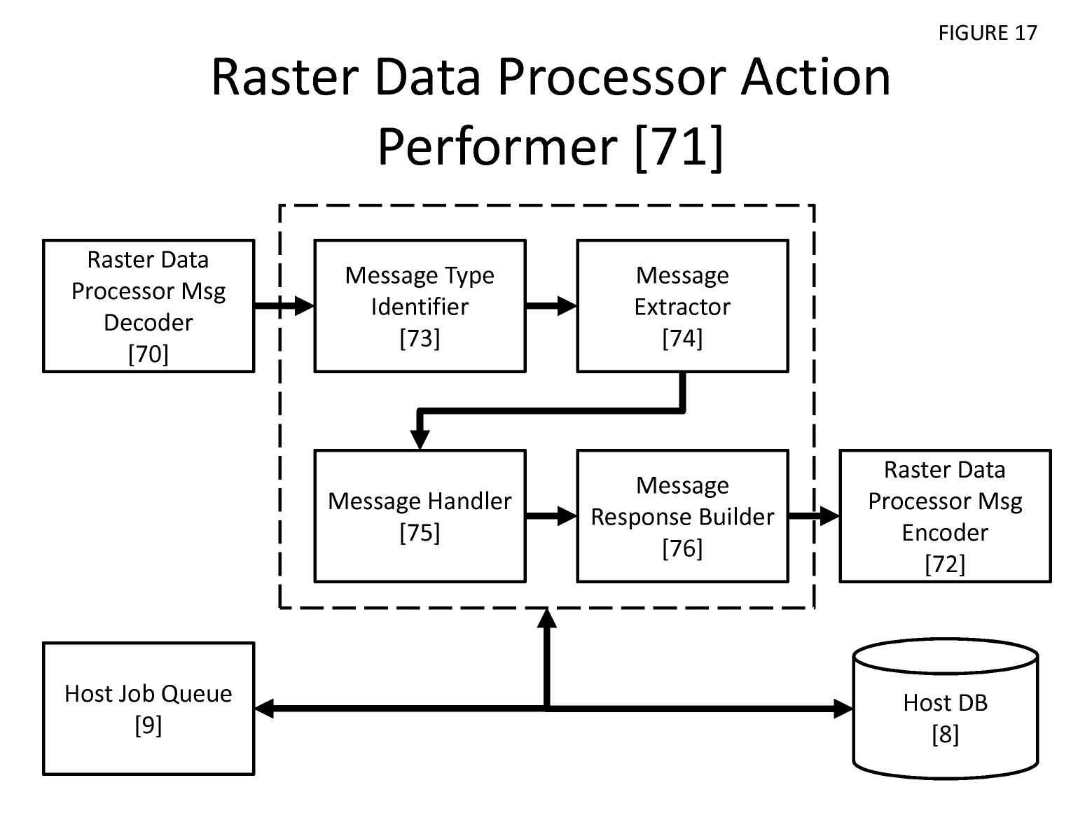

FIG. 17 shows an exemplary Raster Data Processor Action Performer 71, a part of the Raster Data Processor Message Manager 10, which interprets, executes and provides feedback on all messages, sent to the Host 4, from the Raster Data Processor 6. The Raster Data Processor Action Performer 71, depicted in FIG. 17, is responsible for management of all communication by the Host 4, with Raster Data Processors 6, and in coordination with the Host DB 8 and Host Job Queue 9. The Message Type Identifier 73 receives decoded messages from the Raster Data Processor Message Decoder 70 and provides the decoded, classified messages to the Message Extractor 74. The Message Extractor 74 extracts the message and stores it in an internal memory structure, which the Host 4 employs for messaging, and delivers it to the Message Handler 75. The Message Handler 75 coordinates as applicable with the Host Job Queue 9 and the Host DB 8, and sends the resulting message with annotation, as appropriate, to the Message Response Builder 76, which in-turn generates a response message for delivery to the Raster Data Processor Message Encoder 72.

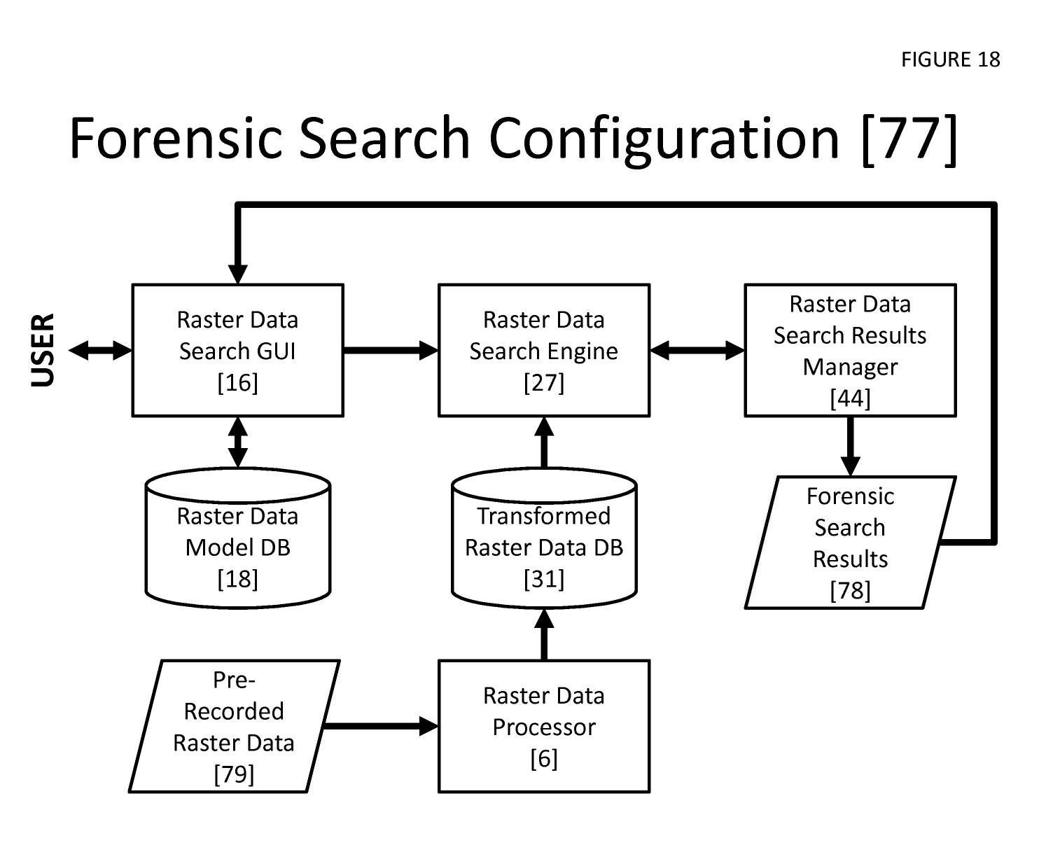

FIG. 18 shows an exemplary Forensic Search Configuration 77 which outlines a configuration of the system to support processing and analysis of pre-recorded raster data. FIG. 18 outlines the Forensic Search Configuration 77, which is employed to search pre-recorded raster data. It can be seen that the user accesses, controls and receives feedback from the Raster Data Search GUI 16, which is the central interface to the system. The Raster Data Search GUI 16 reads and writes search models from and to the Raster Data Model DB 18, sends commands directly to the Raster Data Search Engine 27, and receives and displays Forensic Search Results 78 from the Raster Data Search Results Manager 44. The Raster Data Search Engine 27 receives search models from the Raster Data Search GUI 16, and compares them with transformed raster data stored in the Transformed Raster Data DB 31, which receives is data from the Raster Data Processor 6, which is fed raw Pre-Recorded Raster Data 79. The Raster Data Search Results Manager 44 receives results from the Raster Data Search Engine 27, and is responsible for formatting and storage of the search results.

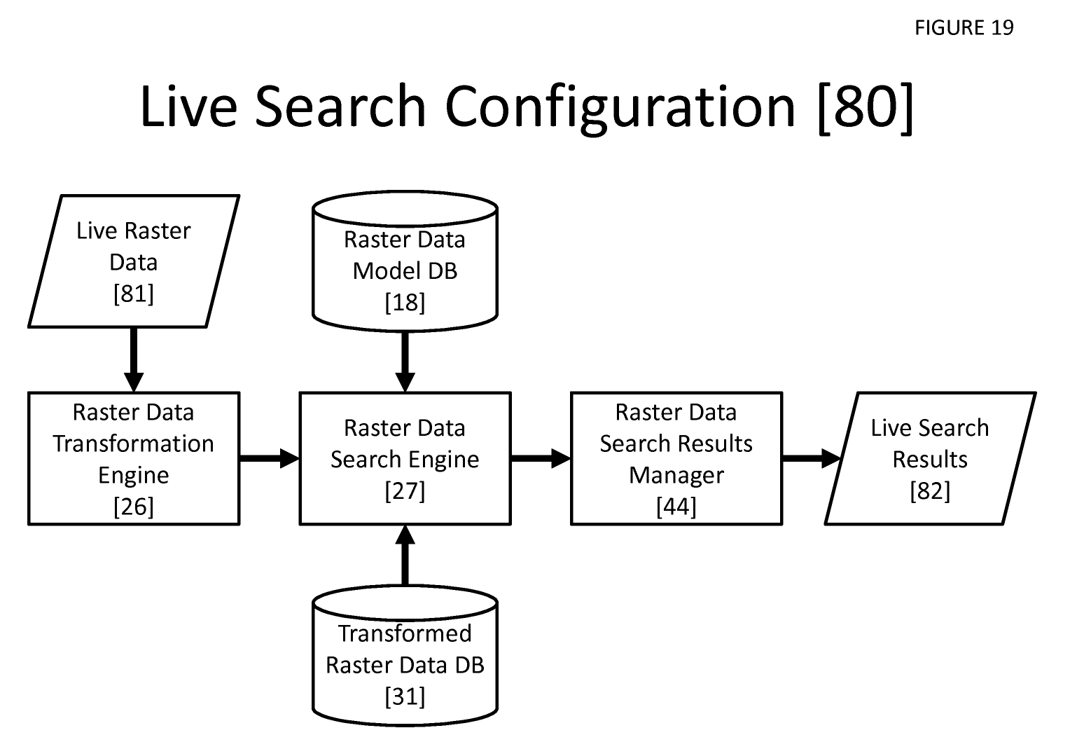

FIG. 19 shows an exemplary Live Search Configuration 80 which depicts a configuration of the system to support processing and analysis of live acquired raster data. The Live Search Configuration 80 is outlined in FIG. 19. It can be seen that Live Raster Data 81 serves as input to the Raster Data Transformation Engine 26 which immediately transforms all raster data and provides it to the Raster Data Search Engine 27. The Raster Data Search Engine 27 employs one or more search models sourced from the Raster Data Model DB 18 to search the transformed raster data received from both the Raster Data Transformation Engine 26 and the Transformed Raster Data DB 31. Results of the search are delivered to the Raster Data Search Results Manager 44 which formats and manages delivery of the Live Search Results 82.

It should be clearly understood that like reference numerals are intended to identify the same structural elements, portions or surfaces, consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A method comprising the steps of:
providing a computer based raster data search system;
providing raster data;
providing one or more search models as a search criteria;
receiving as input said raster data;
transforming by computer said raster data into a mathematical representation of an appearance of said raster data;
storing said mathematical representation of said appearance of said raster data as a set of models in a database;
comparing by computer said at least one search model to said set of models in said database; and
generating a result which indicates a likelihood of a similarity to said search criteria in said raster data.

2. The method of claim 1, wherein said step of providing a raster data comprises providing live raster data.

3. The method of claim 1, wherein said step of providing a raster data comprises providing pre-recorded raster data.

4. The method of claim 1, wherein said step of providing at least one search model comprises providing at least one search model for a search criteria selected from the group consisting of an object, an entity, and a target.

5. The method of claim 1, wherein said step of transforming by computer said raster data comprises transforming by decomposing by computer said raster data into a set of models which represent said appearance of said raster data.

6. The method of claim 1, wherein said step of transforming by computer said raster data further comprises transforming pixels into a dense indexed representation optimized for search.

7. The method of claim 1, wherein said step of transforming by computer said raster data further comprises transforming said raster data into a mathematical representation which is optimized for a massively parallel search.

8. The method of claim 1, wherein said step of comparing by computer comprises a measuring of a likelihood of similarity between example-based raster data models and a transformed raster search data.

9. The method of claim 1, wherein said step of generating a result which indicates a likelihood of a similarity to said search criteria in said raster data further comprises spatio-temporal likelihoods.

10. The method of claim 1, wherein said step of providing at least one search model comprises providing at least one search model for a search criteria which is sourced from one or more example raster data samples.

11. The method of claim 1, wherein said step of providing one or more search models further comprises providing a mathematical model representing the appearance of a user selected entity to be searched for.

12. The method of claim 1, wherein said step of providing a raster data comprises providing a raster data selected from the group consisting of visible light video (RGB, YUV or similar), infrared video (IR), multi-spectral, hyper-spectral, LIDAR, sonar imagery, and RADAR Imagery.

13. The method of claim 1, wherein said step of generating a result further comprises an ability to detect, or reject, single or multiple objects of interest depicted in said raster data.

14. The method of claim 1, wherein said step of generating a result further comprises one or more user controls to dynamically adjust post-processed search results presented to a user in a client GUI through mathematical manipulation of a likelihood of similarity measure.

15. The method of claim 1, wherein said step of generating a result further comprises one or more user controls to either increase a speed of search by reducing an accuracy of the search or to decrease said speed of search by increasing said accuracy of the search.

16. The method of claim 15, wherein one or more objects of interest are selected from the group consisting of physical objects, whole frames (temporal samples thereof) of raster data, multiple frames of raster data, and any arbitrary segment of raster data.

17. The method of claim 1, wherein said step of providing one or more search models for a search criteria further comprises an updating of said at least one search model by submission of one or more added raster data samples.

18. The method of claim 1, wherein said step of providing one or more search model for a search criteria further comprises an updating of said at least one search model by use of a computer system graphical user interface (GUI) by a positive result feedback.

19. The method of claim 18, wherein said step of providing one or more search models further comprises providing recognition to the system that a result was expected.

20. The method of claim 1, wherein said step of providing one or more search models for a search criteria further comprises an updating of said at least one search model by use of a computer system graphical user interface (GUI) by a negative result feedback.

21. The method of claim 20, wherein said step of providing one or more search models further comprises providing feedback to the system that the result was unexpected.

22. The method of claim 1, wherein said step of providing a computer based raster data search system comprises providing a computer based raster data search system including one or more clients configured to accept a user input via a user GUI, a host communicatively coupled to said one or more clients and communicatively coupled to one or more raster data processors, said host configured to maintain communication between said one or more clients and said one or more raster data processors, said one or more clients and one or more raster data processors configured to process raster data as per instructions from the host.

23. The method of claim 1, wherein said step of providing a computer based raster data search system comprises providing a scalable massively parallel processing computer based raster data search system.

24. The method of claim 1, wherein said step of providing a computer based raster data search system comprises providing a computer based raster data search system including a cloud based architecture comprising a Host, Client and Raster Data Processor.

25. The method of claim 24, wherein said cloud based architecture includes multiple hosts which are responsible for managing the processing of raster data.

26. The method of claim 24, wherein said cloud based architecture includes multiple clients which are responsible for accepting user input.

27. The method of claim 24, wherein said cloud based architecture includes multiple raster data processors which are responsible for processing the raster data.

28. The method of claim 24, wherein said cloud based architecture further includes an embedded architecture.

29. The method of claim 24, wherein said cloud based architecture further includes a data transfer protocol that facilitates a communication of messages between elements of a cloud based implementation.

30. The method of claim 29, wherein said communication is selected from the group consisting of a command, raster data, transformed raster data, a mathematical model, a parameter, a status indicator and a node response.

31. A system comprising:
a computer system configured to operate as a computer based raster data search system comprising:
one or more clients configured to accept a user input via a user GUI;
a host communicatively coupled to said one or more clients;
one or more raster data processors communicatively coupled to said host, said host configured to maintain communication between said one or more clients and said one or more raster data processors, said one or more clients and one or more raster data processors configured to processes raster data as per instructions from the host; and
said computer based raster data search system configured to receive as input a raster data, to transform by computer said raster data into a mathematical representation of an appearance of said raster data, to store said mathematical representation of said appearance of said raster data as a set of models in a database, to compare by computer said at least one search model to said set of models in said database, and to generate a result which indicates a likelihood of a similarity to a search criteria in said raster data.
